(19) United States
(12) Patent Application Publication
(10) Pub. No.: US 2005/0179938 A1
(43) Pub. Date: Aug. 18, 2005

(54) Network terminal system

(76) Inventors: Makoto Kayashima, Yokohama (JP); Mariko Kasai, Ebina (JP); Tomohisa Kohiyama, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/893,251

(22) Filed: Jul. 19, 2004

(30) Foreign Application Priority Data
Feb. 13, 2004 (JP) 2004-035906

(51) Int. Cl. G06F 15/00

(52) U.S. Cl. 358/1.15

(57) ABSTRACT

When a presentation is carried out by employing a projector and a remote printer is utilized, printing operation can be executed in a simple and safty manner. In an information processing apparatus having both a network connection function and either a liquid crystal projector function or a printer function, the information processing apparatus can use, or output data which has been stored in a remote computer based upon a remote terminal operating program which may replace a user interface of the remote computer connected via a network to the information processing apparatus, and a remote terminal server program. The remote terminal server program is stored in the remote computer, and is used to transfer a user interface of the remote computer to the information processing apparatus in correspondence with the remote terminal operating program.

### INCORPORATION BY REFERENCE

The present application claims priority from Japanese application JP 2004-035906 filed on Feb. 13, 2004, the content of which is hereby incorporated by reference into this application.

### BACKGROUND OF THE INVENTION

The present invention is related to a method of realizing a user interface of an information processing apparatus.

Conventionally, in the case that presentations are made by utilizing liquid crystal projectors, the following methods have been usually employed. That is, these liquid crystal projectors are connected to external display terminals of notebook type computers. As a result, when presentations are carried out on a projector by a plurality of presenters while these presenters are replaced from each other, such cumbersome works are necessarily required, for instance, notebook type computers must be changed to be connected to the liquid crystal projector. As patent applications capable of solving the above-explained problem, such a system has been proposed (for example, JP-A-2002-170070) which uses both a presentation document disclosure server connected via a network and a projector for displaying a presentation document.

### SUMMARY OF THE INVENTION

As previously explained, in such a case that a device such as a projector is used which is commonly utilized by a plurality of users as a user interface of an information processing apparatus, such a method for accessing presentation documents of the respective users via a network is advantageously employed. However, this accessing method can be hardly used in the case that a specific application program is used so as to display a presentation document, and/or in such a case that a presentation document owns higher security, and the users are prohibited to copy data from a computer under use.

Also, considering such a case that a printer is employed as the user interface of the information processing apparatus, the following method may be advantageously used many times. That is, in this method, in order to print out a document by operating a printer connected to a network, a user executes a print command on a computer, and thereafter, goes to this printer so as to take the printed document at proper timing. Under such a circumstance, when secret information is printed from the printer, the user must go to the printer before the secret document is printed out.

In an information processing apparatus having both a network connection function and either a liquid crystal projector function or a printer function, which constitute a subject unit, since such a software program (remote terminal operating program) is executed which may substitute a user interface (image display and input of keyboard etc.) of a remote computer connected via a network to this information processing apparatus, data which has been stored in this remote computer can be used and/or outputted from the above-explained information processing apparatus. In this case, the remote computer corresponds to such a computer which has stored thereinto the data of the user, and which is connected via the network to the above-described information processing apparatus. Also, the remote computer is provided with a remote terminal server program which corresponds to the above-described remote terminal operating program, and transfers the user interface of the remote computer to the information processing apparatus. This information processing apparatus is capable of using/outputting the data which has been stored in the remote computer from the above-described information processing apparatus based upon both the remote terminal operating program and the remote terminal server program.

In a network terminal system according to the present invention, a user interface of a remote computer which is used by a user is substituted by a liquid crystal projector, so that such a risk that presentation data is utilized by an unfair manner can be decreased.

Also, in the network terminal system of the present invention, when an important file is printed out, a printing process operation of such a remote computer can be carried out, which is being used by a user who is located near the printer. As a result, such a risk that the content of the important file is visually stolen by a third party while the user goes to the printer so as to take the printed result of this important file can be decreased.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram for illustratively showing an entire arrangement of a network terminal system according to an embodiment of the present invention.

FIG. 2 is a block diagram for schematically indicating an internal arrangement of a network terminal 101 employed in the network terminal system of the embodiment.

FIG. 3 is a block diagram for schematically representing an internal arrangement of another network terminal 102 employed in the network terminal system of the embodiment.

FIG. 4 illustratively indicates a construction of software operable on a computer unit 203 and another computer unit 303, which are contained in the network terminals 101 and 102, and a construction of software operable on a remote computer 105.

FIG. 5 is a flowchart for explaining a sequential operation executed in the case that a presentation is carried out by using the network terminal system of the embodiment.

FIG. 6 is a flowchart for describing a sequential operation executed in the case that a printing operation is carried out by using the network terminal system of the embodiment.

FIG. 7 illustratively represents an example of a hardware token which is used by the network terminal system of the embodiment.

### DESCRIPTION OF THE EMBODIMENTS

Referring now to drawings, various embodiments of the present invention will be descried in detail.

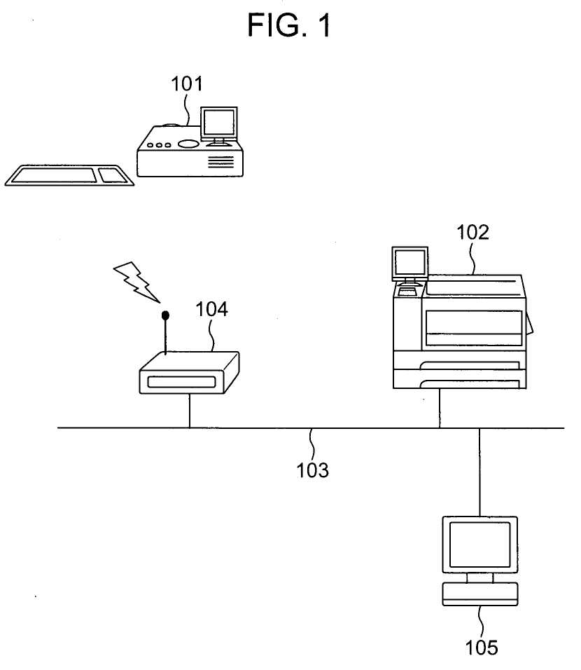

FIG. 1 is a diagram for illustratively showing an entire arrangement of a network terminal system according to an embodiment of the present invention.

In this drawing, numeral 101 indicates a network terminal which contains a liquid crystal projector, numeral 102 represents a network terminal which contains a printer, numeral 103 shows a network, numeral 104 indicates a wireless LAN access point, and numeral 105 shows a computer which is used by a user.

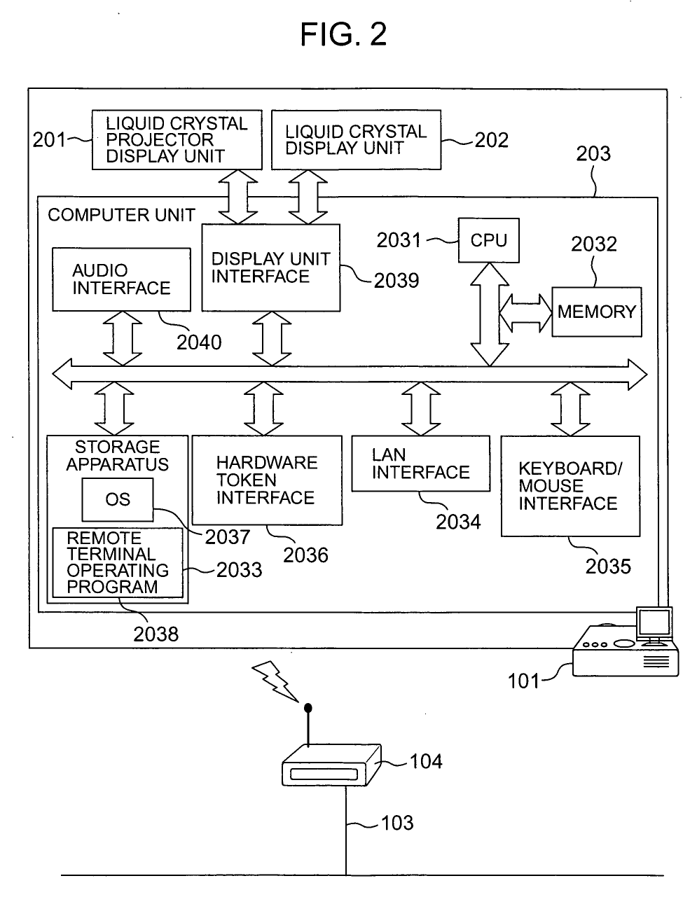

FIG. 2 is a schematic diagram for indicating an internal arrangement of the network terminal 101 employed in the network terminal system of this embodiment. In this drawing, numeral 201 shows a liquid crystal projector display unit; numeral 202 indicates a liquid crystal display unit; numeral 203 represents a computer unit; numeral 2031 is a CPU (Central Processing Unit); numeral 2032 shows a memory; numeral 2033 indicates a storage apparatus; numeral 2034 denotes a LAN interface; numeral 2035 shows a keyboard and mouse interface; and also, numeral 2036 represents a hardware token interface.

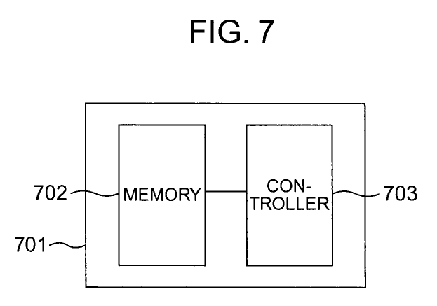

In this specification, a hardware token implies such a storage medium which has stored thereinto such data or information used to access a remote computer by a user. A structure of this hardware token is illustratively indicated in FIG. 7, and will be explained later. An operating system (OS) 2037 and a remote terminal operating program 2038 have been stored in the storage apparatus 2033. The computer unit 203 loads both the operating system 2037 and the remote terminal operating program 2038 to the memory 2032 so as to be operated, so that a graphic output can be switched to either the liquid crystal projector display unit 201 or the liquid crystal display unit 202. Numeral 2039 shows a display unit interface. The display unit interface 2039 owns such a mechanism that in response to an instruction of the above-explained remote terminal operating program 2033, an instruction issued from the user interface 2035 such as a keyboard, or a mouse, and a control signal entered via the LAN interface 2034, this display unit interface 2039 switches a screen display of the remote computer 105 with respect to either the liquid crystal projector display unit 201 or the liquid crystal display unit 202. It should be noted a graphic output corresponds to the same image, or different images from each other. In the case that the different images are displayed, such a case may be conceived. That is, an image for a presentation purpose is displayed from a liquid crystal projector, whereas manuscript for a presenter is displayed on a liquid crystal display. In this embodiment, this network terminal 101 is connected to the network 103 by employing the LAN interface 2034 and the wireless LAN access point 104. Alternatively, this network terminal 101 may be connected to the network 103 by employing such a LAN interface 1034 which is properly adapted to a wired system. Also, numeral 2040 shows an audio interface. This audio interface 2040 may alternatively output an audio signal, or the like to an audio apparatus which is installed in a conference room where a presentation is carried out.

Also, this network terminal 101 may be constituted by employing a plurality of housings within a range where an effect of the present invention is realized. For example, while one portion made by both the liquid crystal projector display unit 201 and the liquid crystal display unit 202 in an integral form is constructed with another portion having the display unit interface 2039 in an integral form, a data communication between these integrally formed portions may be realized by employing a cable and a wireless transmission manner. For example, while the liquid crystal display unit 202, a portion into which the hardware token of the hardware token interface 2036 is inserted, and the keyboard are constructed in an integral form, this integral unit may establish a data communication with respect to another portion. Further, the network terminal 101 may be realized by connecting a notebook type personal computer (PC) having the feature of the present invention to the conventional projector. The hardware token interface 2036 may be alternatively realized by such a manner that both a portion thereof into which the hardware token is inserted and another portion which is connected to another module within a computer unit are separated, and a data communication between both the separated portions is established by way of a cable and a wireless transmission. The keyboard and mouse interface 2035 may be realized by such a way that a data communication between the keyboard and the mouse is established by employing a cable, or a wireless transmission manner. Alternatively, devices which are connected by way of a wireless transmission manner may be stored in one housing.

Furthermore, plural sets of input/output devices which have been stored in a single housing may be alternatively connected to the network terminal 101. As a result, when presentations are carried out by a plurality of persons (presenters), the input/output devices used to perform the presentations may be distributed to the respective persons. In this case, as a set of input/output devices, the liquid crystal display unit 202, the portion into which the hardware token of the hardware token interface 2036 is inserted, and furthermore, the portion combined with either the keyboard or the mouse may be combined with each other. The content of this set may be properly changed, depending upon use purposes.

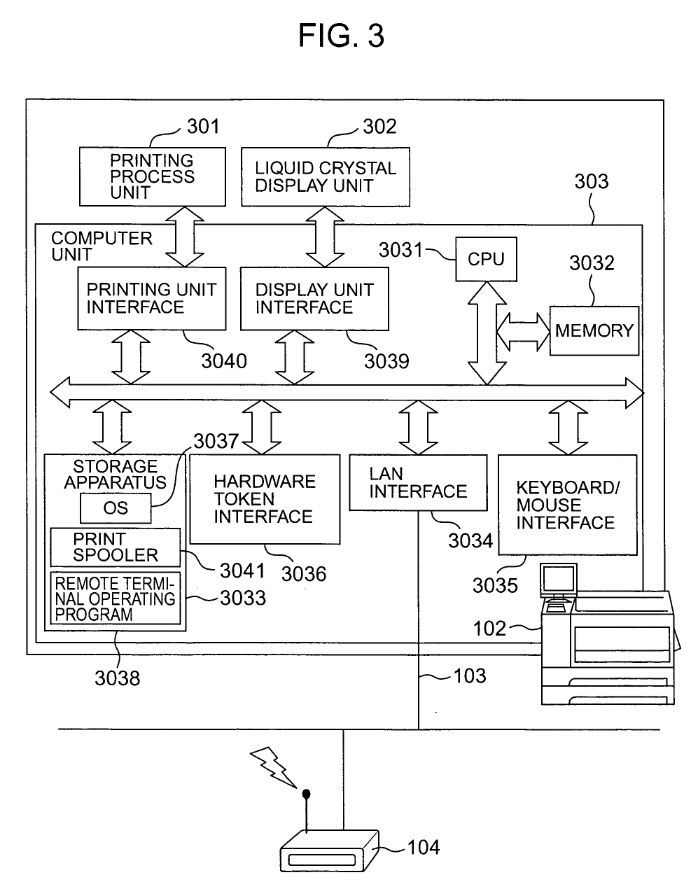

FIG. 3 is a schematic diagram for indicating an internal arrangement of the network terminal 102 employed in the network terminal system of this embodiment. In this drawing, numeral 301 shows a printing unit; numeral 302 indicates a liquid crystal display unit; numeral 303 represents a computer unit; numeral 3031 is a CPU (Central Processing Unit); numeral 3032 shows a memory; numeral 3033 indicates a storage apparatus; numeral 3034 denotes a LAN interface; numeral 3035 shows a keyboard and mouse interface; and also, numeral 3036 represents a hardware token interface. An operating system (OS) 3037, a print spooler program 3041, and a remote terminal operating program 3038 have been stored in the storage apparatus 3033. The computer unit 303 loads the operating system 3037, the remote terminal operating program 3038, and the print spooler program 3041 to the memory 3032 so as to be operated, so that a graphic output is applied to the liquid crystal display unit 302. Numeral 3039 shows a display unit interface. The display unit interface 3039 is used in order that in response to an instruction of the above-explained remote terminal operating program 3033, a screen display of the remote computer 105 is displayed on the liquid crystal display unit 302. Also, numeral 3040 shows a printing unit interface. This printing unit interface 3040 owns such a mechanism that in response to an instruction of the above-described remote terminal operating program 3038, a printing operation of an application program operated on the remote computer 105 is carried out. It should also be noted that the above-explained printing request may be issued as follows: That is, while the printer spooler program 3041 is previously initiated on the network terminal 102, a printing instruction may be alternatively transferred to the printer spooler program 3041 by the remote terminal operating program 3038, and then, the above-described printer spooler program 3041 may alternatively operate the printing unit interface 3040 so as to execute a printing operation. In this embodiment, the LAN interface 3034 may be connected to the network terminal 103 in a wired manner, or may be alternatively connected to the network 103 via the wireless LAN access point 104 in a wireless manner.

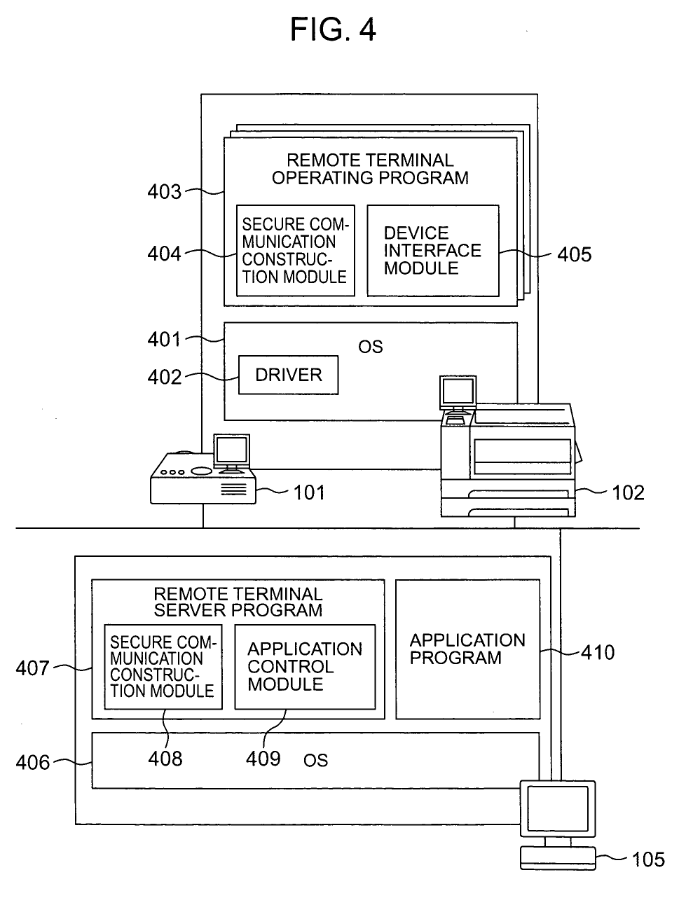

FIG. 4 is a diagram for illustratively representing both structures of software which is operated on both the computer units 203 and 303 contained in the network terminals 101 and 102, and a structure of software which is operated on the remote computer 105.

In this drawing, numerals 401 to 405 indicate a plurality of software which are operated on the network terminals 101 and 102. That is, the software 401 shows an operating system; the software 402 indicates a driver group capable of using input/output devices which are connected to the network terminals 102 and 103; and the software 403 shows a remote terminal operating program. This remote terminal operating program 403 owns such a function that this remote terminal operating program 403 operates input/output interfaces (mouse/keyboard/graphic output apparatus) of a remote computer via input/output interfaces of the network terminals 102 and 103. The remote terminal operating program 403 is arranged by a secure communication construction module 404 and a device interface module 405 used to operate a device.

Numerals 406 to 410 indicate a plurality of software which are operated on the remote computer 105. The software 406 shows an operating system; and the software 407 represents a remote terminal server program. This remote terminal server program 407 is used to transfer an input/output interface of the remote computer 105 to the network terminals 101 and 102 in correspondence with the remote terminal operating program 403. The remote terminal server program 407 is constituted by a secure communication construction module 408 and an application control module 409. Numeral 410 is an application program such as software for executing a presentation and software having a printing function.

In the network terminal system of this embodiment, in such a case that the remote terminal server program 407 is initiated on the remote computer 105, the input/output of the application program 410 is executed by the operating system 406 via the application control module 409 of the remote terminal server program 407. While the application control module 409 employs the secure communication construction module 408 of the remote terminal server program 407 and the secure communication construction module 404 of the remote terminal operating program 403, this application control module 409 transfers an output interface process operation (for example, screen display and pint output) of the application program 410 to the network terminal. The remote terminal operating program 403 executes an output process operation to the output devices of both the network terminals 101 and 102 via the device interface module 405, the operating system 401, and various sorts of drivers 402. Also, while the remote terminal operating program 403 employs the device interface module 405, this remote terminal operating program 403 executes an input interface process operation (for example, input by keyboard, or mouse) of the application program 410. While the remote terminal operating program 403 employs the secure communication construction module 407 of the remote computer 105 and the secure communication construction module 404 of the remote terminal operating program 403, this remote terminal operating program 403 transfers an input with respect to the network terminals 101 and 102 to the remote computer 105. The remote terminal server program 407 executes an input process operation to the application program 410 via both the application control module 409 and the operating system 406.

As previously explained with reference to FIG. 2, in such a case that a plurality of housings which have stored thereinto the sets of input/output devices are connected to the network terminal 101, a plurality of the above-described remote terminal operating programs 403 may be alternatively initiated on the operating system 401 in correspondence with the respective housings.

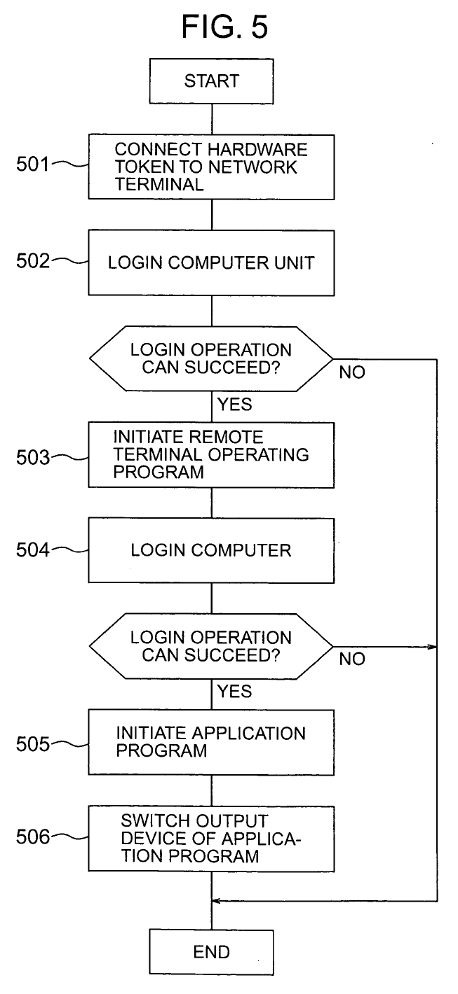

FIG. 5 is a flowchart for explaining a sequential operation by a user when the user uses the network terminal system according to this embodiment to make a presentation.

In this flowchart, Step 501 corresponds to such a step that a hardware token which can certificate an authorized user is connected via the hardware token interface 2036 to the network terminal 101; and Step 502 corresponds to such a step that the user logs in the computer unit 203. In Step 502, authentication may be alternatively carried out by utilizing authentication information which has been stored in the hardware token connected to the network terminal 101. Also, in such a case that users are limited, the above-described Step 502 may be alternatively omitted. Step 503 to Step 506 correspond to such steps that process operations are executed in the case that the user authentication is carried out, and then, since the user authentication can be established, the login operation can succeed, namely a step for initiating the remote terminal operating program 403. Step 504 is such a step that the user logs in the remote computer 105 on the remote terminal operating program 403, namely, while both a network address of the remote computer 105 and the authentication information of the user are utilized which have been stored in the hardware token connected to the network terminal 101, the network terminal system is connected to the remote computer 105 and the user authentication is carried out. Both Step 505 and Step 506 correspond to such steps which are executed in the case that the login operation can succeed. Step 505 corresponds to such a step that the application program 410 is initiated by which the user logs in the remote computer 105, and the user performs a presentation on the remote computer 105. The step 506 corresponds to such a step that a graphic output of the above-explained application program 410 is switched so as to be displayed on the liquid crystal projector unit 201 of the network terminal 101.

In this connection, such an assumption is made. That is, both the user interface used to initiate the remote terminal operating program 403 of Step 503 and the user interface used to initiate the application program 410 of Step 505 are displayed on the liquid crystal display unit 202 of the network terminal 101, and then, the user issues the instruction by employing the mouse and the keyboard. Alternatively, while a button of hardware is provided with the network terminal 101, since the user depresses the above-explained button, the login process operation may be initiated. Also, in Step 506, as to the screen output of the application program 410 initiated on the remote computer 105, the device interface module 405 of the remote terminal operating program 403 operates the display unit interface via both the operating system 401 and the display-purpose driver 402, and then, this screen output of the application program 410 is switched so as to be displayed on the liquid crystal projector unit 201. Alternatively, another application program 410 initiated on the remote computer 105, and/or a portion of a display of the presentation program may be controlled so as to be continuously displayed on the liquid crystal display unit 202 by way of the display unit interface 2039.

As previously explained in FIG. 2, in such a case that plural pieces of the housings into which the sets of the input/output devices have been stored are connected to the network terminal 101, since the sequential operations defined from Step 501 to Step 502 are carried out, a plurality of users can log in the network terminal 101 at the same time. Each of these plural users can log in the own remote computer 105 which is used by the own user in the steps defined from Step 503 to Step 504, and then, can initiate the application program having the function capable of performing the presentation by executing the sequential operation of Step 505. Step 506 for switching the output device of the application program may be alternatively replaced by such a step. That is, while a use condition of the liquid crystal projector display unit 201 is confirmed, in such a case that there is a user who has already utilized this liquid crystal projector display unit 201, such a message that the above-described liquid crystal projector display unit 201 is busy may be resent to another user.

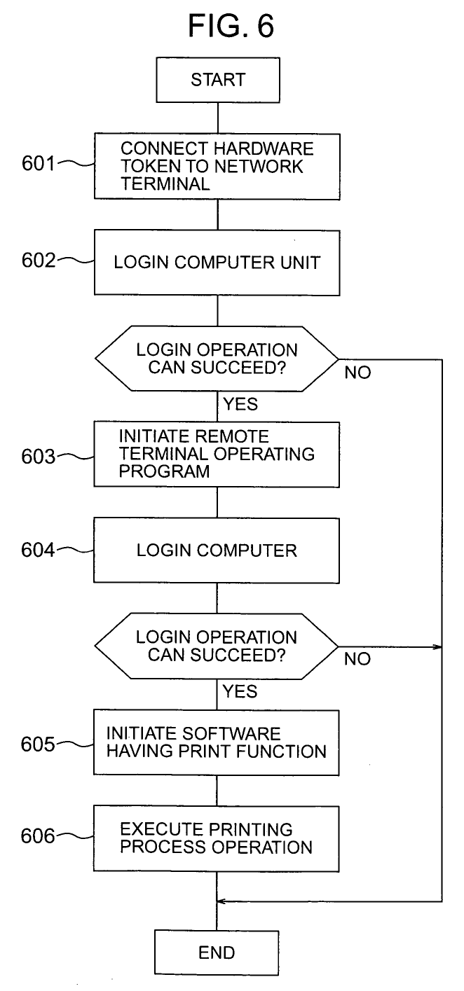

FIG. 6 is a flowchart for explaining a sequential operation executed in such a case that a user performs a printing operation by using the network terminal system according to this embodiment.

In this flowchart, Step 601 corresponds to such a step that a hardware token which can certificate an authorized user is connected via the hardware token interface 3036 to the network terminal 102; and Step 602 corresponds to such a step that the user logs in the computer unit 303. In Step 602, authentication may be alternatively carried out by utilizing authentication information which has been stored in the hardware token connected to the network terminal 102. Also, in such a case that users are limited, the above-described Step 602 may be alternatively omitted. Step 603 to Step 606 correspond to such steps that process operations are executed in the case that the user authentication is carried out, and then, since the user authentication can be established, the login operation can succeed, namely a step for initiating the remote terminal software 402. Step 604 is such a step that the user logs in the remote computer 105 on the remote terminal software 402, namely, while both a network address of the remote computer 105 and the authentication information of the user are utilized which have been stored in the hardware token connected to the network terminal 102, the network terminal system is connected to the remote computer 105 and the user authentication is carried out. It should also be noted that in such a case that the above-described Step 602 is omitted, the process operations defined after Step 603 are carried out. Step 605 corresponds to such a step which is executed in the case that the login operation can succeed. Step 605 corresponds to such a step that the application program 410 having the printing function is initiated on the remote computer 105 in which the user has loged, and then, this printing application program is displayed via the display unit interface 3039 on the liquid crystal display unit 302. Step 606 corresponds to such a step that a printing process operation is carried out by the application program 410 having the printing function, namely, this printing process operation is executed by operating a user interface of the application program 410 displayed on the liquid crystal display unit 302. In this case, the application control module 409 of the remote terminal server program 407 transfers print data to the network terminal 102 via both the secure communication construction module 407 and the secure communication construction module 404 of the remote terminal operating program 403, and since the printing unit interface 3040 is operated by the device interface module 405, the printing operation is carried out by employing the printing unit 301. In this case, since the printer spooler program 3041 having the function capable of accepting a print request is executed, while this pint request is issued from another computer which is connected via the LAN interface 3034 to the network, the network terminal 102 may be alternatively operated in a similar manner to that of the normal network-operable printer. Alternatively, while the above-explained printer spooler program 3041 may be provided with such a function capable of discriminating a print request issued from the remote terminal operating program 403 from another print request issued from another computer connected to the network, this print spooler program 3041 may process the print request issued from the remote terminal operating program 403 with a top priority.

FIG. 7 is a diagram for illustratively showing an example of a hardware token 701 which is used in the network terminal system according to this embodiment. In this drawing, numeral 702 shows a memory unit. The memory unit 702 stores thereinto a user ID (identification) and authentication information, which are employed so as to log in both the network terminal 101 and the network terminal 102; discrimination information (for instance, IP address, domain name, and the like) of the remote computer 105, which is used to be connected to the remote computer 105; and also, both a user ID and authentication information, which are used to log in the remote computer 105. Numeral 703 shows a controller unit. This controller unit 703 connects the hardware token 701 to both the network terminals 101 and 102, and provides the information stored in the memory unit 702 to both the network terminals 101 and 102 at such a stage which is required to execute the sequential operations indicated in FIG. 5 and FIG. 6. In order to avoid such a risk that a third party makes bad use of the hardware token 701, before the authentication information is sent out by the controller unit 703, a sequential operation for confirming the true owner of the hardware token 701 may be alternatively carried out by utilizing the input devices of the network terminals 101 and 102.

The network terminal system according to the present invention may be applied in such a case that a presentation by using a liquid crystal projector, and also, a printing operation is carried out in a safty manner within a system and also outside the system.

It should be further understood by those skilled in the art that although the foregoing description has been made on embodiments of the invention, the invention is not limited thereto and various changes and modifications may be made without departing from the spirit of the invention and the scope of the appended claims.

1. A network terminal system comprising:
an information processing terminal; and
another information processing terminal which is connected via a network to said information processing terminal, wherein:
said information processing terminal includes:
a network connecter which is connected to said network;
a CPU (Central Processing Unit);
an input/output unit of a storage medium which has stored thereinto authentication information;
a storage unit which has stored thereinto a remote terminal operating program for transmitting a signal to said another information processing terminal by being executed by said CPU; and
a bus for connecting said network connecter, said CPU, said input/output unit, and said storage unit to each other, and
said another information processing terminal includes a remote terminal server program capable of using data stored in said another information processing terminal from said information processing terminal in response to the signal transmitted from said information processing terminal by executing said remote terminal operating program.

2. The network terminal system according to claim 1, wherein:
said information processing terminal further includes:
a display input/output unit connected to said bus;
a picture projecting unit connected to said display input/output unit; and
a display unit connected to said display input/output unit, and
said display input/output unit is operable to output data which is transferred from said another information processing apparatus to either one of or both said picture projecting unit and said display unit.

3. The network terminal system according to claim 2, wherein:
said display input/output unit is operable to output images on both said picture projecting unit and said display unit, which are different from each other.

4. The network terminal system according to claim 1, wherein:
said information processing terminal further includes:
a display input/output unit connected to said bus;
a printing process input/output unit connected to said bus;
a display unit connected to said display input/output unit; and
a printing process unit connected to said printing process input/output unit, and
said display input/output unit outputs data transferred from said another information processing apparatus to said display unit, and
said display processing unit is operable to output the data from said printing process unit.

5. The network terminal system according to claim 4, wherein:
in a case that said information processing terminal receives both a print request issued from a further information processing terminal connected via said network and a print request issued from said another information processing terminal, said information processing terminal processes said print request issued from said another information processing apparatus with a top priority.

6. The network terminal system according to claim 1, wherein:
said information processing terminal judges as to whether or not the authentication information acquired from the storage medium, which is entered to said input/output unit, is correct, and
in a case that a judgement result of said authentication information is justified, said information processing terminal is operable to execute said remote terminal operating program.

7. An image output apparatus connected to a network to which at least one information processing terminal is connected, comprising:
a network connecter which is connected to said network;
a CPU (Central Processing Unit);
an input/output unit of a storage medium which has stored thereinto authentication information;
a display input/output unit connected to said display input/output unit;
a picture projecting unit connected to said display input/output unit;
a storage unit which has stored thereinto a remote terminal operating program for transmitting a signal to said information processing terminal by being executed by said CPU; and
a bus for connecting said network connecter, said CPU, said input/output unit, said storage unit, and said display input/output unit to each other,
wherein:
said network connecter transmits a data transfer request of said information processing terminal, which is obtained by executing said remote terminal operating program by said CPU, and
said display input/output unit is operable to output data which is transmitted in correspondence with said data transfer request to either one of or both said picture projecting unit and said display unit.

8. The image output apparatus according to claim 7, wherein:
said display input/output is capable of outputting images on both said picture projecting unit and said display unit, which are different from each other.

9. An image output apparatus according to claim 7, wherein:
said network connecter, said CPU, said display input/output unit, and said picture projecting unit are formed as a first housing, whereas said input/output unit and said display unit are formed as a second housing.

10. The image output apparatus according to claim 9, wherein said image output apparatus owns plural sets of said second housings.

11. The image output apparatus according to claim 9, wherein said first housing and second housing are separate housings.

12. The image output apparatus according to claim 7, wherein:
said image output apparatus judges as to whether or not the authentication information acquired from the storage medium, which is entered to said input/output, is correct, and
in a case that a judgement result of said authentication information is justified, said image output apparatus is operable to execute said remote terminal operating program.

13. An image output apparatus connected to a network to which at least one information processing terminal is connected, comprising:
a network connecter which is connected to said network;
a CPU (Central Processing Unit);
an input/output unit of a storage medium which has stored thereinto authentication information;
a display input/output unit;
a display unit connected to said display input/output unit;
a printing process input/output unit;
a print processing unit connected to said printing process input/output unit;
a storage unit which has stored thereinto a remote terminal operating program for transmitting a signal to said information processing terminal by being executed by said CPU; and
a bus for connecting said network connecer, said CPU, said input/output unit, said storage unit, said display input/output unit, and said printing process input/output unit to each other,
wherein:
said network connecter transmits a data transfer request of said information processing terminal, which is obtained by executing said remote terminal operating program by said CPU;
said display input/output unit outputs data which is transmitted in correspondence with said data transfer request to said display unit, and
said print processing input/output unit is operable to output said data from said print processing unit.

14. The image output apparatus according to claim 13, wherein in a case that a reception is made of both a print request issued from another information processing terminal connected via said network and a print request issued from said image output apparatus, said print request issued from said another information processing apparatus is processed with a top priority.

15. The image output apparatus according to claim 13, wherein:
said image output apparatus judges as to whether or not the authentication information acquired from the storage medium, which is entered to said input/output unit, is correct, and
in a case that a judgement result of said authentication information is justified, said image output apparatus is operable to execute said remote terminal operating program.
